(19) United States
(12) Patent Application Publication
(10) Pub. No.: US 2015/0278351 A1
(43) Pub. Date: Oct. 1, 2015

(54) METHOD AND SYSTEM FOR RECOMMENDING MULTIMEDIA CONTENTS THROUGH A MULTIMEDIA PLATFORM

(71) Applicants: RAI RADIOTELEVISIONE ITALIANA S.P.A., Roma (IT); S.I.SV.EL SOCIETA ITALIANA PER LO SVILUPPO DELL'ELETTRONICA S.P.A., None (TO) (IT)

(72) Inventors: Alberto Messina, Torino (IT); Sabino Metta, Torino (IT); Maurizio Montagnuolo, Torino (IT)

(73) Assignees: S.I.SV.EL SOCIETA' ITALIANA PER LO SVILUPPO DELL'ELETTRONICA S.P.A., None (TO) (IT); RAI RADIOTELEVISIONE ITALIANA S.P.A., Roma (IT)

(21) Appl. No.: 14/433,593

(22) PCT Filed: Oct. 4, 2013
(86) PCT No.: PCT/IB2013/059115

§ 371 Date: Apr. 3, 2015

(30) Foreign Application Priority Data
Oct. 5, 2012 (IT) TO2012A000867

(51) Int. Cl. G06F 17/30

(52) U.S. Cl. CPC G06F 17/30746; G06F 17/30796

(57) ABSTRACT

A method for recommending multimedia contents through a multimedia platform (101) having observable multimedia contents includes the steps: receiving a first command (204) from a user interface (10) to select a first multimedia content (1) associated with semantic information; receiving from the user interface (10) a user identifier, a second command to select multimedia content (2) associated with semantic information, and further receiving a piece of information (11) relating to an association between multimedia contents (2, 1), concerning a semantic aggregation; processing (12) a first state representative of the user identifier, of the first (1) and second (2) multimedia contents, and of the association (11), through a comparison between pieces of semantic information; the multimedia platform recommends a third multimedia content (3), based on the first processed state (12) and on a comparison with a further state.

### FIELD OF THE INVENTION

The present invention relates to a method and a system for recommending multimedia contents.

### PRIOR ART

Nowadays, the quantity of accessible multimedia contents is huge and constantly increasing. Very large amounts of information (images, videos, documents, comments on social networks, . . . ) are continually being produced, archived and shared among numerous users. In such a context, the way in which a user gains access to information of interest takes crucial importance.

In order to retrieve a generic content of interest, a user can issue a search request in text format, called query. Subsequently, an Information Search & Retrieval system analyzes the content of the query and compares it with suitable “indices” of available contents. Such indices are normally predefined and built on the basis of a content analysis.

The information associated with the multimedia content itself is notoriously referred to in the literature as “metadata”.

The system then returns, by using different modalities and metrics, the content which best meets the user's request expressed through the query.

The importance of the metadata during this content search and retrieval process is apparent. The more numerous and representative the metadata, the more efficient is the content identification and retrieval process.

In order to facilitate this multimedia content search and retrieval process, “recommendation systems” are used, the function of which is to identify with better accuracy multimedia contents that may anticipate the users' needs and expectations.

One example of a multimedia content recommendation system is known from document US2007/0208718A1, which describes a media server comprising a recommendation system that provides the user with a customized program guide.

In general, it is essentially possible to identify two categories of recommendation systems, which are summarized below.

Collaborative filtering recommendation systems generate recommendations on the basis of previous selections made by “similar users”. In fact, users are grouped into stereotypes defined by a set of preferences. The assumption at the basis of these collaborative systems is, therefore, that the behaviour of a group of users can be used to deduce the behaviour of a single user belonging to that group.

Document U.S. Pat. No. 6,438,579B1 describes a collaborative recommendation system wherein multimedia contents are proposed to the user based on a correspondence between content evaluations given by the user him/herself and evaluations of other contents given by other users, according to a group behaviour logic.

Content-based filtering recommendation systems generate recommendations by comparing the user's preferences (whether explicitly or implicitly expressed) and the characteristics of the contents that he/she has already used with metadata or characteristics associated with contents to be recommended. The user's preferences are explicitly obtained when the user deliberately provides his/her evaluations; important information can also be extracted by automatically recording and monitoring the user's actions. The characteristics of the contents used by the user are typically extracted by means of audiovisual content analysis algorithms.

One example of a content-based recommendation system is known from document US2011/0125585A1, which describes a recommendation system that proposes contents of potential interest for a user on the basis of the user's previous behaviour, received from a user platform.

However, the solutions known in the art of multimedia content recommendation systems do not prove to be fully satisfactory.

In fact, a user wanting to enjoy a multimedia content interacts with the information search and retrieval system in a wholly personal manner, and may decide to explore more deeply some contents instead of others on the basis of his/her own cultural and contextual needs, which can hardly be identified beforehand.

In general, a user may express a query in an inaccurate manner, or by using words for which synonyms exist which might lead to better results. In addition, the predefined content indexing used by recommendation systems, which is generally associated with an importance or similarity concept, necessarily implies a univocal interpretation of the queries. The consequence of these aspects is that the recommendation system may return to the user results that do not fully fulfill his/her needs.

The user is thus compelled to have a time-consuming interaction with the recommendation system; however, this interaction is often “forgotten” by the system after the search has been completed, so that it becomes difficult, even for the user him/herself, to reconstruct the interaction dynamics at a later time.

### BRIEF DESCRIPTION OF THE INVENTION

It is one object of the present invention to provide a method and a system overcoming some of the drawbacks of the prior art.

In particular, the invention aims at providing a multimedia content recommendation method and system capable of more efficiently retrieving multimedia contents of interest for a user by exploiting the representation and storage of information about the interaction between the user and the system.

It is another object of the present invention to provide a multimedia content recommendation method and system allowing to use to advantage the associations possibly made by the user during his/her previous fruition experience.

These and other objects of the present invention are achieved through a method for recommending multimedia contents, and an associated system, incorporating the features set out in the appended claims, which are an integral part of the present description.

The present invention is based on the general idea of providing a method for recommending multimedia contents wherein: a command is received from a user through a suitable user interface to reproduce at least one first multimedia content, along with an associated first piece of semantic information; through a suitable user interface, the user issues a selection of at least one second multimedia content, with which at least one second piece of semantic information is associated, along with information relating to an association between the second multimedia content and the first multimedia content being observed, said information concerning a semantic aggregation; the system processes at least one first state representative of the user's identity, of the first multimedia content and the second multimedia content, and of the association, through a comparison between the second piece of semantic information and the first piece of semantic information; at least one second state representative of at least one third multimedia content is recommended, based on the first processed state and on a comparison with at least one further state of a plurality of states relating to said plurality of multimedia contents.

The present invention also relates to a system for recommending multimedia contents which comprises a first memory storing multimedia contents and respective first pieces of semantic information, a processor and at least one user interface adapted to reproduce at least one first multimedia content. The system further comprises at least one second memory adapted to store at least one second multimedia content selected through the user interface, at least one second piece of semantic information, and a user identifier, and further adapted to store at least one piece of information relating to an association between the second multimedia content and the first multimedia content being observed, received through said user interface and concerning a semantic aggregation. The processor is adapted to process information relating to the user, to the first multimedia content and the second multimedia content, and to the information about the association, in order to compare at least said second piece of semantic information with said first piece of semantic information and to elaborate at least one first information state. The second memory is adapted to store the first information state, and the processor is further adapted to process information relating to the first information state and to the multimedia contents in order to elaborate at least one second information state representative of at least one third multimedia content in the first memory, to be recommended to the user, on the basis of a comparison with at least one further state of a plurality of states relating to said plurality of multimedia contents.

In this way, the system allows the user to express semantic relations, not only time relations, between two or more multimedia contents. Therefore, a user can associate any multimedia content or “artefact” with a resource, giving it a precise and explicit semantic meaning. Said meaning, which can be derived and interpreted by the recommendation system, is then used in order to provide more effective recommendations.

The solution herein proposed allows therefore to overcome the drawbacks of the prior art because, first of all, it provides a new and more complete way of recommending multimedia contents which is based on interaction analysis and comprehension and on the user's characteristics.

This solution offers considerable advantages, and performs a recommendation system's functions more effectively.

As a result, the system can exploit the wealth of information produced by the interaction for the purpose of improving the performance for a specific user or, more generally, for a community of users.

The method and the system herein proposed allow to associate further multimedia contents generated by the user (audio, video, text or aggregates thereof) with a given set of contents being observed, as well as to create complex contents by aggregating observed and generated contents.

At the same time, the user is given the possibility of associating with each multimedia content information that characterizes and enriches the interaction between the user and the system.

The essential advantage of this invention over the prior art is that the user is given the possibility of providing the system with much more information than is currently exchanged, thus re-establishing an information balance between system and user. It is conjecturable that such a balance can improve the performance of the information system in terms of higher adaptability to the user's information needs, which can be fully expressed through the advanced interaction functions proposed herein.

In fact, the increased expressiveness available in the stream of multimedia contents being reproduced can be more effectively exploited by the system, thus reducing the uncertainty in the association between indexed contents and user's requests.

In the solution herein proposed, the information search and retrieval process follows in a more effective manner the association process carried out by the user while enjoying multimedia contents.

Advantageously, the proposed invention allows to bridge the gap now existing between the user's queries and the actual demand for information contained therein.

At the same time, the proposed invention allows to bridge the gap between the wealth of possible shades in the interpretation of the contents observed by the user and the generic ability of recommendation systems of preserving such information in a persistent and reusable manner.

### BRIEF DESCRIPTION OF THE DRAWINGS

Further objects and advantages of the present invention will become more apparent from the following detailed description and from the annexed drawings, which are supplied by way of non-limiting example, wherein:

FIG. 1 exemplifies the method for recommending multimedia contents;

FIG. 2 exemplifies the system for recommending multimedia contents;

FIG. 3 exemplifies a generic recommendation about a multimedia content for a user;

FIG. 4 exemplifies a generic recommendation about a plurality of multimedia contents for a user;

FIG. 5 shows an example of recommendation of a multimedia content;

FIG. 6 shows a second example of recommendation of a multimedia content.

In the annexed drawings, similar elements, actions or devices are identified by the same reference numerals in different figures.

### DETAILED DESCRIPTION

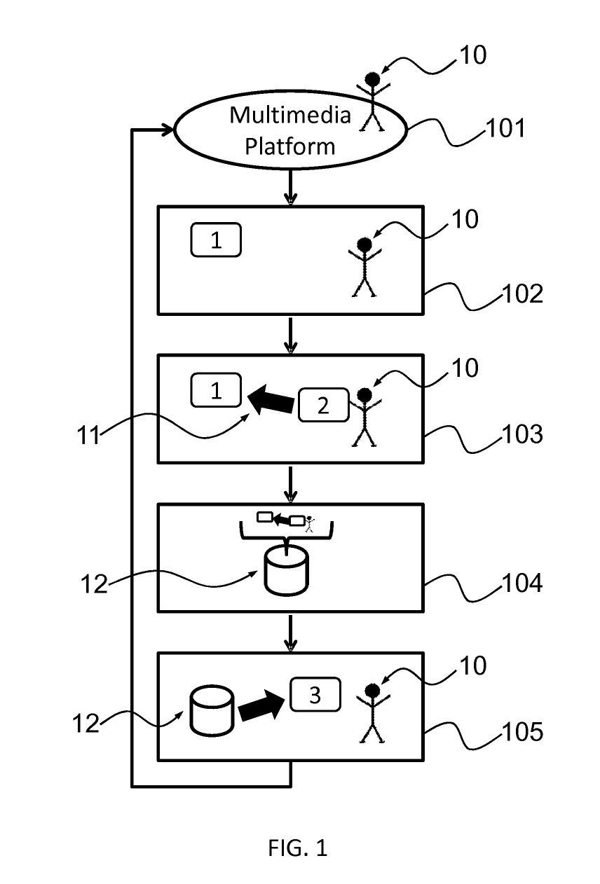

FIG. 1 exemplifies the method for recommending multimedia contents.

A user 10 is enjoying multimedia contents on a multimedia platform, such as a multimedia platform allowing access to videos, images, audio, text and/or other multimedia contents.

This multimedia platform is representative and exemplificative of the numerous multimedia platforms now available, which are typically accessible through the Internet by using devices such as computers, “Connected TV/IPTV” television sets, smartphones, personal digital assistants, tablets, etc.

The user 10 can interact with the multimedia platform in order to retrieve multimedia contents: at step 101, according to the present invention, the user 10 interacts with the multimedia platform, thus starting the process that will lead to content recommendation. Said interaction taking place at step 101 may be of several types, wherein the user 10, in order to fulfill his/her own need to deepen his/her knowledge of a particular subject, searches for multimedia contents; for example, the user 10 may browse a predetermined list of recently loaded multimedia contents, or make a keyword-based content search, or browse a list of already recommended contents.

The user 10 interacts with the multimedia platform through a suitable user interface (which can be considered to be included in the same reference 10), which will be described more in detail below. Furthermore, the multimedia platform recognizes the user 10 through a user identifier, which for the purposes of the present invention can be considered to correspond to the identity of the user him/herself, e.g. via a known username and password system.

At step 102, the user 10 wants to observe a multimedia content 1 on the multimedia platform; to this end, the user 10 issues a command, through a suitable user interface, to have the multimedia platform reproduce said multimedia content 1, whether video, audio, image or the like. In this context, the action of “observing” carried out by the user 10 should not be understood to be limited to actual watching by the user 10 (who may even, for example, not pay attention to the video being played, leaving it muted in the background); instead, it is meant to include the possible scenarios related to a selection command issued by the user 10 and the subsequent presentation or reproduction of the content 1 by the multimedia platform.

At step 103, the user 10 loads another multimedia content 2 on the platform through the user interface thereof, associating it with the multimedia content 1 just observed at step 102. For example, the user 10 may load a video 2 that was residing in the memory of his/her own terminal, or even from a third device, such as a camera, connected thereto.

It must be pointed out that a multimedia content 2 loaded by the user 10 may take several forms, which may be produced by the user 10 while interacting with the multimedia platform: such multimedia contents may be audiovisual, or tags, text annotations, audio, etc. In this manner, the interaction of the user 10 moving between different “states” can be modelled, wherein the transition from one “state” to another does not exclusively occur through fruition or observation of a multimedia content, but also by loading additional multimedia contents.

Within the scope of the present description, the term “state” takes a connotation which has some connections with the definition of state according to mathematical physics and the systems theory.

In such frames, the concept of “dynamic system” represents a system whose evolution over time can be described by means of a general mathematical model. Such a mathematical model is characterized by suitable laws that bind the present “state” to the future and/or past state. Thus, the multimedia content system is actually a dynamic system that may assume a more or less large plurality of states.

In the present description, it has been chosen to define the “state” of a dynamic system as the set of values of the characteristics of the system itself, which define its condition at any time instant.

The definition of a model allows to know the evolution of the system over time, i.e. the subsequent states thereof, starting from information relating to the previous states.

As aforementioned, the fruition of multimedia contents by a user can be considered to be subject to a such dynamic system.

In the case of multimedia content recommendation systems, the “state” is the particular condition in which the user-multimedia fruition pair is. Knowing or, even better, foreseeing the evolution of such a dynamic system leads to a recommendation system which can more effectively fulfill the user's needs.

It is therefore necessary to define a particular set of variables that characterize the fruition of multimedia contents; the higher the number of variables, the greater the granularity with which fruition is described. However, the larger the quantity of information taken into account, the harder it is to manage the evolution of the system. Specific variables that can be used in an exemplary embodiment of the present invention will be described below.

One possible alternative formulation of the term “state” as defined in the present description is therefore “information state”.

During the loading operation at step 103, the user 10 implicitly or explicitly expresses an association 11 between the content observed at step 102 and the content loaded at step 103; said association 11 expresses an affinity between the first multimedia content 1 being observed and the second multimedia content 2 being loaded by the user 10, as will become more apparent below.

Said association 11 can be expressed through a semantic comparison between text data providing information describing the content itself, such as, for example: annotation, comment, title, summary, etc.

Said association 11 may also be a logic one, such as, for example: sharing, positive example, negative example, opposition, suggestion, reference, source, contribution, implication, derivation, query. This last type of association (query) models the classic situation in which the user uses a text content (a series of keywords) or a multimedia content (a reference image) in order to search for other contents.

Said association 11 may also be a time-based or logic-causal one, such as, for example: previous/next, antecedent, consequent.

Said association 11 may further be a structural and compositive one or an aggregative one, such as, for example: part of, aggregated with. Association primitives of this type allow composing aggregates of multimedia objects that can be identified as “composite” multimedia objects.

Of course, it can be assumed, as an obvious generalization, that the user 10 can define specific associations 11 in addition to the predefined ones available on the multimedia platform.

At step 104, the multimedia platform extrapolates a plurality of pieces of abstract information relating to the state that occurred at steps 102 and 103, in particular information comprising:
an identifier of the user 10;
an identifier of the first multimedia content 1 being observed;
a first piece of semantic information of the first multimedia content 1 being observed;
an identifier of the second multimedia content 2 loaded by the user 10;
a second piece of semantic information of the second multimedia content 2 being observed;
an identifier representative of the association 11 just made, concerning a semantic aggregation.

The possibility of storing the above-mentioned information relating to the interaction of the user 10 along with the multimedia contents provides automatic learning and allows to deepen the knowledge derivable from such complex data. Furthermore, the particular form of storage may allow the information to be shared among a plurality of multimedia platforms, thus improving the multimedia experience of the user 10.

At step 105, the multimedia platform processes the information extrapolated at step 104, so as to reconstruct at least one further state that identifies a further multimedia content 3 to be recommended to the user 10 as potentially interesting.

The recommendation made at step 105 makes use of a “Data Mining” engine that utilizes the information stored at step 104, expressed in a suitable and preferably standard syntax, in order to recommend multimedia contents in accordance with parameters set in an interaction model, in particular on the basis of a comparison with at least one further state of a plurality of states relating to multimedia contents.

Preferably, based on the specific association 11 set by the user 10 when loading the content 2, a specific recommendation mechanism is established by the system.

In this manner, the “path” built by the user's interaction is not simply given by a time sequence: the user chooses to “bind” together those multimedia resources which he/she thinks are close, i.e. related, from a semantic viewpoint. In addition, the user also has the possibility of expressing said bond by attributing a precise semantic qualification to it.

At this point, having available an explicit semantics (i.e. type of relation) between two or more states, the system can give the user a recommendation which is closer to his/her needs.

If, for example, the user associates the second multimedia content 2 with the first multimedia content 1 by means of the “opposition” concept, the system can exploit such explicit knowledge to learn which characteristics of the second multimedia content 2 diverge most from the first multimedia content 1, and thus deduce that any other contents having such characteristics can also be classified as “in opposition”.

Likewise, if the user associates the second multimedia content 2 with the first multimedia content 1 by means of the logic-causal “consequent” concept, the system can exploit the intrinsic transitivity of such a concept to establish causal networks between the contents, which allow to reach and recommend to the user 10 contents reachable in such networks by starting from the multimedia content 2.

Finally, if the user associates the second multimedia content 2 with the first multimedia content 1 by means of the compositive “aggregated with” concept, thus implicitly creating a set of objects which are mutually relevant on the basis of a user-defined logic, the system can exploit this situation by analyzing which characteristics of the aggregated multimedia contents 2 and 1 are in common, and then recommending further objects which are more similar to the multimedia contents 2 and 1 on the basis of such characteristics.

From all this, a scenario emerges wherein, unlike the prior art, which prefers recommendation schemes defined a priori (e.g. a specific collaborative recommendation method), the system can implement an adaptive approach to recommendation.

The above-exemplified method enriches and improves the user's participation in the multimedia content recommendation process.

In a wider frame, through the use of composition operators between multimedia contents to generate new “aggregate” contents, the user also has the possibility of composing “new” aggregate multimedia contents by using the multimedia contents observed and those generated by him/herself. At the same time, the user attributes to such multimedia contents, whether implicitly or explicitly, a specific association that they have in the interaction with the multimedia content being observed. This mechanism potentially establishes and infinite cycle of compositive recursivity among multimedia contents, which represents a step forwards compared to prior-art recommendation systems.

In a preferred embodiment, the multimedia platform models the process of interaction of the user engaged in the fruition of multimedia contents, representing it through a formal language based on the RDF (Resource Description Framework) standard, referred to as OWL (Web Ontology Language). The OWL language is a semantic markup language for World Wide Web publishing and sharing.

Through the use of the OWL language, one can formalize the interaction process described with reference to FIG. 1 by means of classes, relations among classes and individuals belonging to classes. Those relations which are not explicitly presented can be derived logically from the analysis of the ontology semantics, by applying automatic reasoning methods implementing inferential and deductive processes.

The following lists the ontology Classes in the preferred embodiment that uses the OWL language.

User: a person who is engaged in the fruition of a multimedia content on one or more devices. The user is the main actor of the multimedia experience.

Event: an abstract representation of a generic real event.

State: a specific event, identified by a set of “variables” or “coordinates” univocally identifying the set of interaction atoms and their respective roles in a given state of the multimedia experience.

Usage Event: a specific event which occurs every time the user decides to actually use an observable (e.g. when the user is reading a text, watching a video, . . . ).

Multimedia Experience: the complex set of events (states and usage events) representing the fruition by the user, within a given time interval, of a certain number of multimedia contents.

Multimedia Object: any type of data that can be handled by a device in order to produce multimedia contents, e.g. in video, audio, text formats. The description of a multimedia object may include its low-level characteristics (e.g. the “colour histogram” of a video). A multimedia object can play a role as an observable or as an artifact during a state of a multimedia experience. Multimedia objects comprise the following types of objects:
Text;
Image;
Video;
AudioVisual;
Audio.

Interaction Atom: an abstract representation of observables and artefacts.

Observable: a specific multimedia object that the user may decide to use, while in a specific state, during his/her multimedia experience. An observable is any multimedia object visible to the user in a specific state (e.g. an image in the graphic interface).

Artefact: a specific multimedia object added to an observable by the user while in a specific state. An artefact is any multimedia object actively generated by a user (e.g. tags, annotations, voice) or selected by the user during a specific state of his/her multimedia experience.

Role: a sort of metadata that expresses the functionality of an interaction atom (e.g. an observable or an artefact) while in a specific state. For example, if the user adds a text part (artefact) with the intention of annotating an image (observable), then the role of such text will be “annotation”.

In the RDF languages, a generic statement or piece of information (i.e. any simple concept) is described through a “triplet”: Subject-Verb-Object. The “Verb” represents the relation/property through which the “Subject” is bound to the “Object”. The syntax for expressing said statement requires:
a range (or co-domain), i.e. a class representing the “Object”
a domain, i.e. the class to which the relation (“Verb”) can be applied and which represents the “Subject”

The following lists the relations between ontology Classes in the preferred embodiment using the OWL language.
characterizesArtefact:
   domain: ‘Multimedia Object’ range: ‘Artefact’. This property expresses the fact that, in a certain state, a multimedia object has the artefact role.
characterizesMExp
   domain: ‘State’ range: ‘Multimedia Experience’. This property binds a multimedia experience to its constituent states.
characterizesObservable
   domain: ‘Multimedia Object’ range: ‘Observable’. This property expresses the fact that, in a certain state, a multimedia object has the observable role.
composedBy
   domain: ‘Interaction Atom’ range: ‘Interaction Atom’. This property takes into account the compositions (e.g. spatial or time relations) between two interaction atoms.
describesState
   domain: ‘Observable’ range: ‘State’. This property associates observables with respective states.
followsState
   domain: ‘State’ range: ‘State’. This property models the time sequence of states. It is a transitive property.
hasArtefact
   domain: ‘State’ range: ‘Artefact’. This property binds the states to the respective constituent artefacts.
hasMultimediaExperience
   domain: ‘User’ range: ‘Multimedia Experience’. This property associates the users with the multimedia experiences.
hasObservable
   domain: ‘State’ range: ‘Observable’. This property binds the states to the respective constituent observables.
hasRole
   domain: ‘Interaction Atom’ range: ‘Role’. This property associates a role with an interaction atom (an observable or an artefact) while in a specific state.
hasUsageEvent
   domain: ‘Observable’ range: ‘UsageEvent’. This property records the actual use of an observable while in a specific state.
has User
   domain: ‘MultimediaExperience’ range: ‘User’. This property associates the multimedia experiences with the respective users.
partOf
   domain: ‘Interaction Atom’ range: ‘Interaction Atom’. This property is the inverse of ‘composedBy’ and allows an inverse bond between the composed interaction atoms and the respective entities.
perturbsState
   domain: ‘Artefact’ range: ‘State’. This property expresses the relation between states and artefacts.
precedesState
   domain: ‘State’ range: ‘State’. This property is the inverse of ‘followsState’.
isSemanticallyRelatedTo
   domain: ‘State’ range: ‘State’. This property models the semantic relation between states.

The proposed ontology allows to “model” the users engaged in a multimedia experience by mapping multimedia objects. When the user is interacting with the multimedia platform by observing contents and loading further contents, he/she causes a change of information state, which is interpreted by the multimedia platform. The user can enrich a certain multimedia content by associating therewith a further multimedia content, thus modifying the information state of the platform. In general, the model can fully capture the user's behaviour, his/her interaction with any multimedia content, and the roles played by the objects during the interaction.

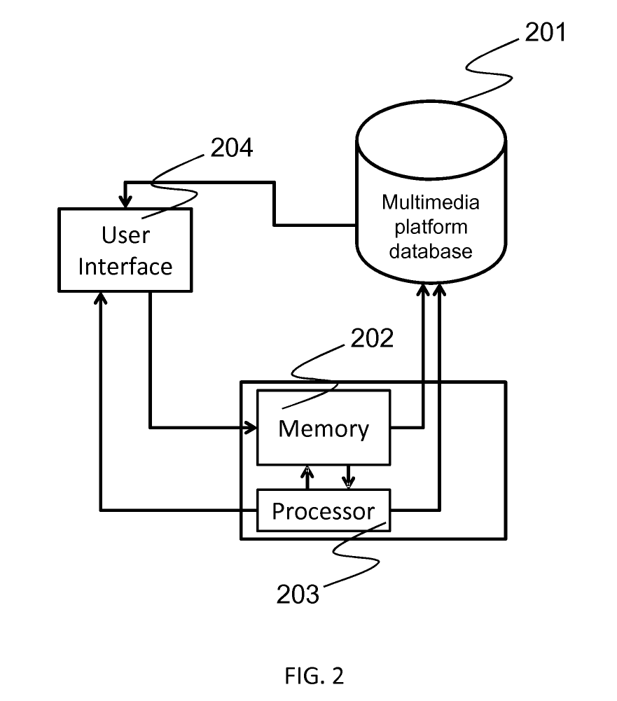

FIG. 2 exemplifies an embodiment of a multimedia platform, or a system for recommending multimedia contents.

The system for recommending multimedia contents comprises a first memory 201, which stores a plurality of multimedia contents, such as video, audio, images, text, etc.

The system further comprises a memory 202 and a processor 203, which are operationally connected to the first memory 201. In particular, the memory 202 may be either volatile or non-volatile, whereas the memory 201 is preferably a permanent one. The processor 203 is adapted to access the memory 202 and to perform operations on data stored therein.

The system further comprises at least one user interface 204, through which the user 10 (see FIG. 1) can gain access to the multimedia platform. Through the user interface 204, the user can reproduce and observe at least one first multimedia content. Through the user interface 204, the user can also load a further multimedia content into the memory 202. Through the user interface 204, the user can also signal an association, expressed as digital information, between the second multimedia content just loaded and the first multimedia content being observed.

The processor 203 is adapted to process the information relating to the user (10, see FIG. 1), to the first multimedia content being observed (1, see FIG. 1), to the second multimedia content being loaded (2, see FIG. 1), to the semantic information about the first and the second multimedia contents, and to the association (11, see FIG. 1) between them, particularly as a semantic aggregation.

The processor 203 can thus select a further multimedia content (3, see FIG. 1) of potential interest for the user, by first calculating at least one first information state, which is stored in the memory 202, and by processing the information relating to the first information state and to the plurality of multimedia contents stored in the memory 201 of the platform, in order to elaborate and calculate at least one second information state representative of a third multimedia content (3, see FIG. 1) in the first memory 201, to be recommended to the user.

Such processing takes place through a comparison, in accordance with vicinity rules, with a plurality of possible further states relating to the plurality of multimedia contents of the platform.

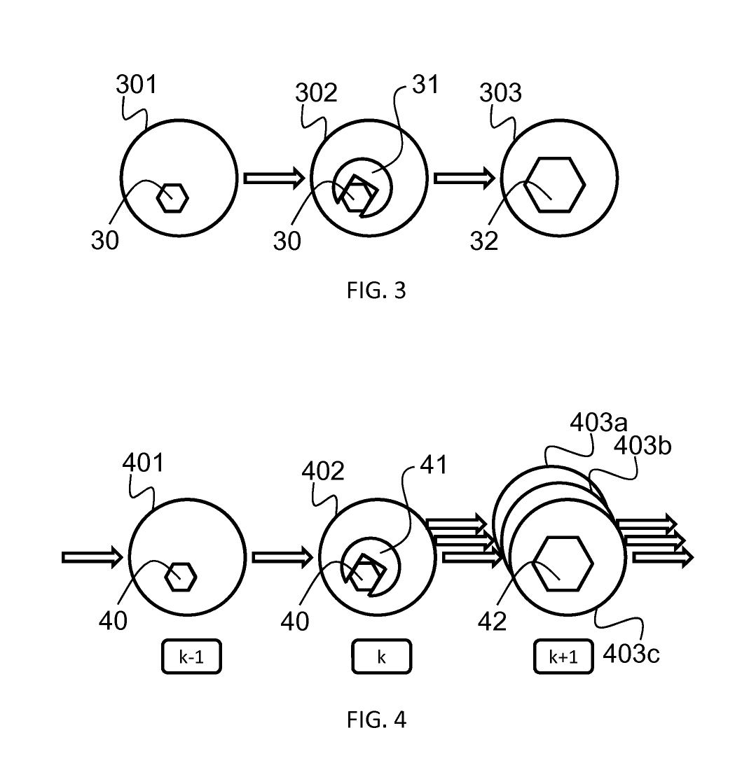

FIG. 3 represents a recommendation of a multimedia content to a user, obtained by means of a transition between information states as previously described.

The information search and retrieval process carried out by the user consists of an evolution of a system that switches from one “state” to another, as summarized above. In the fruition of multimedia contents, the “state” is represented by the set of characteristics associated with the user 10 and with the multimedia contents usable by the user 10 within a given space-time and logic context.

The transition from one state to another occurs after the action through which the user associates a multimedia content with another multimedia content available on the platform.

In the state 301, the user is observing a multimedia content 30 on the multimedia platform. As previously described, the user decides to associate with the multimedia content 30 a further multimedia content 31 by specifying association information exemplified in the drawing by the composition of the contents 30 and 31 one over the other, thus getting into the state 302. In the state 303, based on information about the state 302, the multimedia platform recommends a further multimedia content 32 to the user.

Every action of the user has thus the effect of changing an information state relating to the multimedia contents observable and provided by the user, and to their mutual association.

FIG. 4 represents a recommendation of multiple multimedia contents for a user, obtained by means of a transition between information states as previously described.

At the functional level, a transition from one state to another occurs every time the user expresses an interaction primitive. The number and quality of such interaction primitives depend on the defined roles and on the composition potentialities available on the platform.

In the state 401, the user is observing a multimedia content 40, with which he/she associates, by composition, a further content 41, thus getting into the state 402. Starting from the state 402, the multimedia platform recommends a plurality of multimedia contents to which a plurality of potential states 403a, 403b, 403c correspond. The recommendation method can then be iteratively repeated, arriving at very complex aggregation states and allowing to effectively and fully exploit the information made available by the user. The user's interaction may be hypothetically iterated an unlimited number of times. While switching from one state to the next, the pieces of information associated with the multimedia contents nest one into the other, thereby generating complex and information-rich structures. The possible iterations of the recommendation method are underlined by the fact that respective labels k−1, k and k+1 are associated with the different states 401, 402 and 403, k being an integer number greater than or equal to 1.

An embodiment is also conceivable wherein the recommendation of a certain multimedia content depends on an arbitrary number (even greater than one) of previous states, and wherein the information that can be inferred from these previous states concurs in providing the recommendation of a further multimedia content. Such an embodiment can capture a richer and more complex scenario to fulfill the user's desires at best.

In a particular embodiment, one can define a set of interaction primitives, expressed by means of the OWL language, e.g. as follows:
add(<artefact(1); role(1)>) The primitive adds an artefact and its specific role.
add(<observable(k); role(k)>) The primitive adds an observable and its specific role.
find-similar(observable(1)) The primitive finds an object which is “similar” to observable(1).

The possibility of permanently storing, e.g. into a memory of the recommendation system, the complex information about the interaction between the users and such systems, allows a number of direct utilizations of such information by known data mining, machine learning and knowledge discovery technologies and methods, upon which multimedia content indexing and retrieval systems can be based. This further highlights the possibility of setting up additional recommendation techniques based on the information model proposed herein, which can fully exploit the information wealth of the latter.

The following will describe some examples showing the functionalities of a few embodiments of the method for recommending multimedia contents.

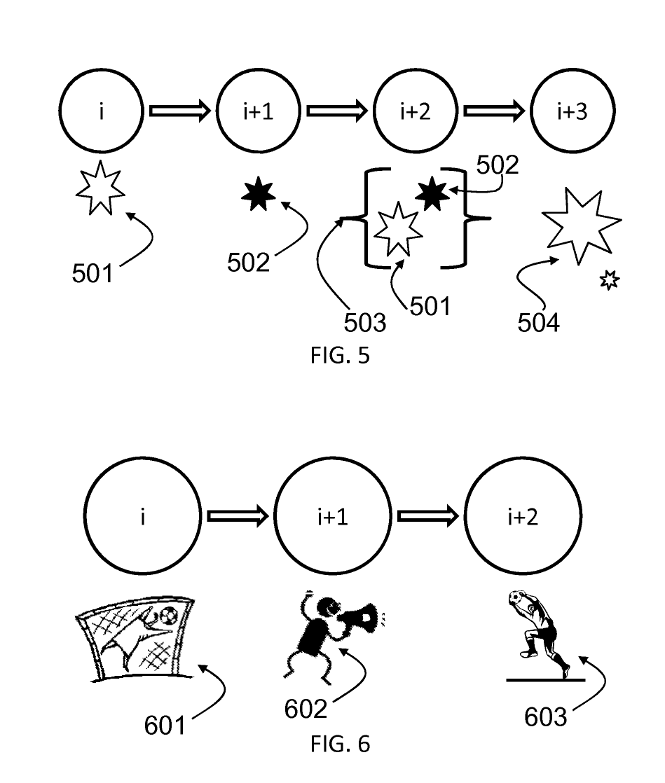

With reference to FIG. 5, the user may load a multimedia content, specifying its association as an annotation. A user begins his multimedia experience by observing the image of a star 501: the user is in the state ‘i’ characterized by an observable(1), where i indicates an integer number greater than or equal to 1. Subsequently, the user interacts with the multimedia platform by searching and finding a star 502, i.e. observable(2), which is similar to the initial one. This action causes a state transition: from ‘i’ to ‘i+1’. Finally, the user decides to collect both stars and aggregates the two observables into the complex content {observable(1), observable(2)} 503. To this object, the user adds the annotation “These two stars are similar”; this action, defined by a specific interaction primitive, causes a transition from the state ‘i+1’ to a state ‘i+2’. By considering the text information “similar” and the images of the two stars 501 and 502, the multimedia platform will be able to recommend to the user further images 504 of similar stars, e.g. by relying on an image search engine.

With reference to FIG. 6, the user may load a multimedia content, specifying its association as a comment. A user begins his multimedia experience by watching a video 601: the “blunder” made by his idol Bruffon during the match versus Lemme on Feb. 5, 2015. This is the state ‘i’, characterized by an observable(1). Saddened by the goalkeeper's mistake, he decides to leave a comment on it by recording his voice: the audio track containing the user uttering the sentence “Bruffon you are still the best” is the artefact 602. The user decides to add this audio clip 602 as a comment, associating it with the initial video. This action causes a state transition: from ‘i’ to ‘i+1’. The multimedia platform is equipped with a voice transcription engine that reconstructs the text uttered by the user and, by considering the sound “Bruffon” as related to the video description, it will be able to recommend to the user further videos 603 of Bruffon, in the state ‘i+2’.

Further examples are presented below, which are not specifically associated with any particular drawing and can be fully understood by referring to the already described FIGS. 3 and 4.

The user may load a multimedia content, specifying its association as a source.

A user is reading an article ‘w1’ on the Internet, concerning a fact occurred during a television program. In this case as well, the user is technically in the state T, characterized by an observable(1).

Then the user decides to search for the television program that originated the content of ‘w1’, just watched on the Internet. The user searches and finds ‘tv1’: this action changes the state ‘i’ into ‘i+1’. Finally, the user decides to collect both contents (web and TV) by associating the “source” role with the observable ‘tv1’. This association, defined by a specific interaction primitive, changes the state ‘i+1’ into ‘i+2’.

The user may load a multimedia content, specifying its association as derivation and annotation.

A user begins his multimedia experience by listening to an audio clip containing a song, in particular a famous hit of the 70's: technically, the user is in the state ‘i’, characterized by an observable(1). Subsequently, the user interacts with the system by searching and finding a more recent musical video concerning a modern cover, observable(2), of the initial song. This action causes a state transition: from to ‘i+1’. The user specifies a role as “derivation” from the initial audio clip. Finally, the user decides to collect the audio clip and the video by annotating this collection (complex observable) with the annotation “the video of this song is a cover”. This action, defined by a specific interaction primitive, changes the state ‘i+1’ into ‘i+2’. The multimedia platform then returns further modern covers of songs by the original band of the 70's. The user may load a multimedia content, specifying its association as a query.

A user begins his multimedia experience by reading a gossip article: the user is in the state ‘i’, characterized by an observable(1). The article includes written text and a photo. The text tells about the last flirt of a famous American actor, while the photo shows him in a scene of a popular movie. From the photo, i.e. observable(2), the user recognizes the scene, but cannot remember the title of the movie from which it was extracted. The user then selects the photo, thereby changing state from ‘i’ to ‘i+1’, and uses it as a “query”, associating it with the name of the famous American actor. The multimedia platform then returns the trailer of the movie from which the scene was extracted.

The user may load a multimedia content, specifying its association as antecedent and consequent.

A user begins his multimedia experience by looking at a funny photograph of his granddaughter trying to blow out her first birthday candle. The user is in the state ‘i’, characterized by an observable(1). The user realizes that in the same folder there is a video of his granddaughter, i.e. observable(2), taken a few months before the photograph. To the latter, the user decides to add the artefact ‘observable2’ with the antecedent role, thereby generating ‘observable3’: the state thus changes from ‘i’ to ‘i+1’. This action causes the grandfather (i.e. the user) to remember a poem written for his granddaughter before she was born. The poem, i.e. ‘observable3’, has been saved on the desktop. Prior to turning off the computer, the grandfather decides to associate the video and the photo (an artefact), interpreting, them as consequent, with said poem. The multimedia platform, through face recognition software, associates with the poem further multimedia contents, such as photographs and videos, featuring the granddaughter.

The user may load a multimedia content, specifying its association as implication and suggestion.

A user, Mrs. Rossi, only likes watching culinary contents on the TV. Her husband Mr. Rossi, instead, mainly watches television programs dealing with sports contents. Mrs. Rossi, while she is alone at home, begins her multimedia experience by turning on her interactive television set and tuning to CHANNEL X (state ‘i’), which is broadcasting a program about Calabria's typical gastronomic products (observable(1)). At this point, the woman decides to communicate to the system the fact that she, when watching the TV alone, only likes programs dealing with matters similar to those currently being broadcast. By pressing (for example) the blue key on the remote control, the woman starts a specific action: the video camera integrated into the television set takes a photograph, thus recording, among other things, Mrs. Rossi's face.

Let us now assume that, by using the photograph taken by user, the system can, through known techniques, recognize the person's face and hence her identity.

The photograph (artefact) is given the implication role. The state changes from ‘i’ to ‘i+1’.

In the evening, Mr. Rossi is back from work. His wife is in the kitchen, preparing dinner. Before sitting down at the table, Mr. Rossi decides to watch something on the TV. He turns on the TV, which automatically tunes to CHANNEL X (state ‘k’), that is, the last channel watched by his wife. Mr. Rossi sits in front of the TV, which is now broadcasting a content ((observable(k))) that is not of much interest to him. Not knowing which program to choose and being too lazy to check the program schedule, Mr. Rossi asks the system for a suggestion (role).

By simply pressing (for example) the red button on the remote control, the video camera integrated into the television set takes another photograph (artefact). The system recognizes the user and proposes, based on information saved in the past (e.g. information about the program watched the evening before or on previous days) a program that is broadcasting live an important rugby match.

By way of example, the following parameters may constitute a possible “fruition-user” system (along with other parameters not listed for the sake of simplicity): genre, geographic position, event type, etc.

Said parameters may take the following values (along with further values not taken into account herein for simplicity):

genre: politics, sports, news, etc.
geographic position: Italy, Germany, etc.
event type: concert, earthquake, etc.

Let us now assume that, at the initial time instant t0, the “fruition-user” system is in the “state” state(t0), characterized by

state(t0): politics, Italy, elections, etc.

In this initial state, the system has no information about the user's preferences yet. The recommendation system might recommend a multimedia content on the basis of predefined schemes (collaborative or content-based systems) in accordance with the prior art.

At a certain instant, the user chooses to use a second multimedia content, selected by him according to his desires, even not belonging to the above-mentioned predefined schemes.

After fruition by the user, the fruition condition switches from the initial state state(t0) to a subsequent state(t1), e.g.
state(t1): politics, Germany, elections, etc.

At this stage, the recommendation system automatically detects the relation existing between the two consecutive states, i.e. state(t0) and state(t1). In fact, the characteristic parameters of the two states differ by one field, with which a semantic piece of information is associated, i.e. “geographic position”. In other words, the states state(t0) and state(t1) are bound by an explicit semantic relation, which is machine-readable and whose availability depends on the particular ontology used for the formalization of the interaction model.

While using multimedia contents, the user is thus given the possibility of “jumping” from one state to another and of “aggregating” such states as a function of a variety of relations provided by said ontology.

Here are a few examples of relations:
state(t0) is analogous to state(t1),
state(t0) is caused by state(t1),
state(t0) is different from state(t1),
   etc. . . .

To continue the above example, the user chooses to watch a second multimedia content selected according to his desires, and hence “jumps” from state(t0) to state(t1).

At this point, the user decides to bind said states by means of the relation
state(t0) is analogous to state(t1)

The recommendation system uses the semantic information associated with the multimedia contents and the semantic aggregation information concerning the different states; such semantic aggregation information may be provided as:

(i) implicit relations, i.e. characteristic parameters of the states, allowing to discern which state the user is in, and
(ii) explicit relations, expressed by the user him/herself.

In the present example, the user implicitly communicates the relation that semantically binds the two states, in this case “different geographic position”, to the recommendation system.

Said implicit relation becomes the evolution model through which the recommendation system can provide a “potential” state (t2)

state(t2): politics, Sweden, elections, etc.

The term “potential” used herein takes into account the fact that it is not mandatory for the user, when choosing the content of state(t1), to necessarily cause the fruition to collapse on state(t2): many other alternative would also be possible.

Every fruition choice made by the user can thus confirm the reliability with which the recommendation system provides recommendations about multimedia contents.

To continue the example, in the event that the user actually decides to use the content associated with the state state(t2), then the recommendation system will generate a further potential state(t3):

state(t3): politics, Romania, elections, etc.
and so on.

The user has the possibility of binding two (or more) multimedia contents by means of one or more relations.

In general, the recommendation system is adapted to acquire information about relations existing between two or more states, whether implicitly, by comparing the characteristic parameters of two different states, or explicitly, through the action carried out by the user.

In other words, the multimedia platform, receiving the command for selecting a second multimedia content with which a respective piece of semantic information is associated, is able receive (whether implicitly or explicitly) information about the association between the multimedia contents being observed by the user, which association concerns a semantic aggregation.

As regards the use of an explicit relation, let us assume that the user ends the initial fruition (referred to in the above example) and, even after some time, starts another fruition f0 (to which the present example refers).

Let us assume that during said fruition f1 the user gets into the state state(t1) again, identical to the state arrived at during the fruition but not necessarily coming from the same state state(t0) from which the fruition f0 began.

At this point, the recommendation system may recommend to the user the characteristic content of the state state(t0) (politics, Italy, elections, etc.), by adding further semantic aggregation information, i.e.: state(t0) is analogous to state(t1).

Through the formalization of, semantic aggregations between pieces of semantic information associated with different multimedia contents and states, the recommendation system can adapt itself to the particular choices of the user, which depend, in principle, on the state of fruition and on any previous states encountered along the multimedia fruition path.

While increasing the complexity of the system, this allows to generate a semantic aggregation of multimedia contents that can better fulfill the user's requests.

It should be noted that the “a posteriori” use of such aggregations among states is totally unbound from the time consecutiveness logics that generated the states themselves.

As also shown by the numerous examples, one of the main advantages of the invention is that the proposed method can model the interaction of a user engaged in the fruition of a certain set of multimedia contents, and that the user is given the possibility of adding further multimedia contents while also associating a specific role with such contents.

The proposed method and system allow to keep track of the information and to elaborate the investigation process carried out by the user, who can enrich a given multimedia content with other contents of his/her own in a rich and complex manner. In this way, a possible information search and retrieval phase is extremely facilitated, because the search and retrieval systems can fully exploit the model's information wealth. In fact, search and retrieval systems can dynamically enrich their indices by using information about the roles associated with the objects of the users' interaction, along with grouping and composition information provided by the users themselves. The recommendation system based on the present method can thus better meet the user's requirements.

The proposed method and system are particularly suited for implementation by means of a computer program to be loaded and executed on a computer.

Said computer preferably belongs to a network of computers, e.g. connected via the Internet, wherein at least one of the devices, particularly the one accessible to the user, is a PC, a laptop, a tablet, a smartphone, a media center, a television set or any other functionally equivalent device.

As the man skilled in the art will appreciate, the proposed method may be subject to many variations. For example, the ontology has been described herein, without limitation, with reference to the OWL language; however, other languages may be used, such as, for example, XML Schema.

Furthermore, the information about the behaviour of the user or of a community of users engaged in the fruition of multimedia contents can be recorded, shared and reused efficiently also among heterogeneous technologic platforms.

Also, the method may be simultaneously integrated into different devices, such as: interactive TV's, mobile phones, tablets, PC's. In this manner, the behaviour of the users of a plurality of devices can be traced and then such information can be used for new applications.

1. A method for recommending multimedia contents through a multimedia platform, wherein said multimedia platform comprises a plurality of multimedia contents observable through at least one user interface, comprising the following steps:
said multimedia platform receives at least one first command from said at least one user interface to select at least one first multimedia content with which at least one first piece of semantic information is associated;
said multimedia platform receives from said at least one user interface a user identifier, a second command to select at least one second multimedia content with which at least one second piece of semantic information is associated, and further receives at least one piece of information relating to an association between said at least one second multimedia content and said at least one first multimedia content being observed, said at least one piece of information concerning a semantic aggregation;
said multimedia platform processes at least one first state representative of said user identifier, of said at least one first multimedia content and said at least one second multimedia content, and of said association, through a comparison between said second piece of semantic information and said first piece of semantic information;
said multimedia platform recommends at least one second state representative of at least one third multimedia content, based on said at least one first processed state and on a comparison with at least one further state of a plurality of states relating to said plurality of multimedia contents.

2. The method according to claim 1, wherein said at least one second multimedia content received from said at least one user interface is a content which is directly generated through an acquisition device of said at least one user interface.

3. The method according to claim 1, wherein said at least one second multimedia content comprises images and audio, preferably being a video.

4. The method according to claim 1, wherein said at least one piece of semantic aggregation information is obtained from a text comparison between text information associated with said first piece of semantic information and with said second piece of semantic information.

5. The method according to claim 1, wherein said at least one piece of information relating to an association is further obtained from a time comparison between time information associated with said at least one first multimedia content being observed and with the time instant of reception of said at least one second multimedia content.

6. The method according to claim 1, wherein said first state and said second state are associated with a plurality of stored pieces of information adapted to represent respective conditions of said recommendation system.

7. A system for recommending multimedia contents, comprising a first memory storing a plurality of multimedia contents and a plurality of respective first pieces of semantic information, a processor and at least one user interface adapted to reproduce at least one first multimedia content, at least one second memory adapted to store at least one second multimedia content (2) selected through said user interface, at least one second piece of semantic information, and a user identifier, and further adapted to store at least one piece of information relating to an association between said at least one second multimedia content and said at least one first multimedia content being observed, said piece of information being received through said user interface and concerning a semantic aggregation; wherein said processor is adapted to process information relating to said at least one user identifier, to said at least one first multimedia content and said at least one second multimedia content, and to said at least one piece of information relating to an association, in order to compare at least said second piece of semantic information with said first piece of semantic information and to process at least one first information state, and wherein said second memory is adapted to store said at least one first information state, and wherein said processor is further adapted to process information relating to said at least one first information state and to said plurality of multimedia contents, in order to elaborate at least one second information state representative of at least one third multimedia content in said first memory, wherein said processor is adapted to make a comparison with at least one further state of a plurality of states relating to said plurality of multimedia contents.

8. A system for recommending multimedia content configured to implement the method according to claim 1.

9. A computer program comprising instructions which, when executed on a computer, implement the method according to claim 1.

10. The computer program according to claim 9, wherein said program comprises instructions compiled by using the Web Ontology Language in accordance with the Resource Description Framework standard.
